(19) United States
(12) Patent Application Publication
(10) Pub. No.: US 2008/0156301 A1
(43) Pub. Date: Jul. 3, 2008

(54) Dust Separation Device

(75) Inventors: Jim Rockwell, Bellville, OH (US); Robert J. Steinman, Lexington, OH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: STONERIDGE, INC., Warren, OH (US)

(21) Appl. No.: 11/866,067

(22) Filed: Oct. 2, 2007

Related U.S. Application Data
(60) Provisional application No. 60/827,832, filed on Oct. 2, 2006.

(51) Int. Cl. F02M 33/02; B01D 50/00

(52) U.S. Cl. 123/518; 55/385.3

(57) ABSTRACT

A dust separation device for separating contaminants from a fluid. The device may include at least one spiral fin disposed in an inlet tube for directing at least a portion of the contaminants in a spiral flow, and a deflector for deflecting at least a portion of the contaminants into a into a collection chamber. A fuel system for an internal combustion engine and a method of separating contaminants from a fluid are also provided.

### CROSS-REFERENCE TO RELATED APPLICATIONS

This application claims the benefit of the filing date of U.S. Provisional Application Ser. No. 60/827,832, filed Oct. 2, 2006, the teachings of which are hereby incorporated herein by reference.

### FIELD

The present disclosure relates to a dust separation device for removing contaminants from an air flow.

### BACKGROUND

A vapor management system of an internal combustion engine may ingest large volumes of dust, especially into canister vent valve and carbon canister portions of the system. This potentially produces an unacceptable flow path restriction and reduces performance. In the presence of severe conditions, some emission requirements may become difficult to meet and in-service failures may result.

A dust separating filtration device may be used in the vapor management system to block contaminants that may accompany the intake of fresh air. Filters used in the past include foam filters, but these may increase flow resistance after a long service period. Some filters used in the past have narrow flow paths, which may cause high flow resistance.

### BRIEF DESCRIPTION OF THE DRAWINGS

Features and advantages of solenoids consistent with the present disclosure will be apparent from the following description of embodiments consistent therewith, wherein:

FIG. 1 is a schematic diagram of a fuel system for a gasoline internal combustion engine to which a device consistent with the present disclosure may be applied;

FIG. 2 is a sectional view of one exemplary embodiment of a dust separation device consistent with the present disclosure; and

FIG. 3 is a sectional view of another exemplary embodiment of a dust separation device consistent with the present disclosure.

### DESCRIPTION

For ease of explanation, dust separation devices will be described herein in connection with an engine vapor management system. A dust separation device consistent with the present disclosure may, however, be useful in other applications. It is to be understood, therefore, that illustrated exemplary embodiments described herein are provided only by way of illustration, and are not intended to be limiting.

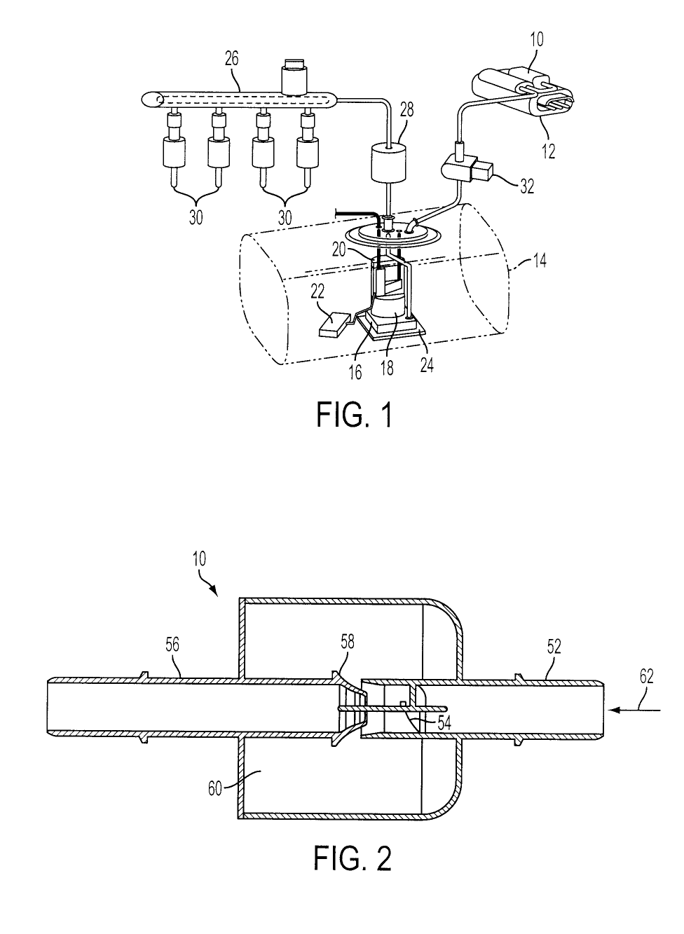

FIG. 1 illustrates one embodiment of a fuel system of an internal combustion engine. The illustrated exemplary fuel system includes a fuel tank 14 containing fuel and fuel delivery devices, which include a fuel pump 16, a brushless motor 18, motor drive electronics 20, a fuel sender 22, a filter 24, an indicator, hydraulic valves, a delivery module cup, pipes and other supplemental devices. Fuel at high-pressure may be sent to a fuel rail 26, located on an engine, through an inline fuel filter 28. Fuel injectors 30 may inject fuel into the air charge entering the engine through an intake manifold (not shown). The fuel vapor, however, may be sent through a fuel tank pressure sensor 32 to a vapor management system.

The vapor management system may include a dust separation device 10 (also called a dust box), which may be connected by fluid passages to a fuel vapor storage canister 12. In one mode of operation, when the fuel tank 14 is being filled, fuel vapor may be transported into the vapor storage canister 12, and clean air, exiting the canister, enters the device 10 and escapes into the atmosphere. In another operation mode, the system may allow fresh air to purge the fuel vapor stored in the vapor storage canister. During this process, some contaminants may enter the vapor management system. The dust separation device 10 may block the contaminants and allow filtered air into the system.

FIG. 2 illustrates one exemplary embodiment of a dust separation device 10 consistent with the present disclosure. The illustrated exemplary embodiment includes an inlet tube 52 including one or more spiral fins 54 in a spiral orientation relative to the axis of the tube 52, an outlet tube 56 including a dust deflector 58, and a collection cavity 60. The spiral fins 54 inside the inlet tube 52 are configured to direct incoming dust laden air in a spiral flow pattern. The spiral pattern velocity causes contaminants in the air stream to move toward the outer edge of the flow area, against the interior wall of the inlet tube 52, due to centrifugal force. As the air progresses down the inlet tube 52 past the fins 54 the contaminants near the interior wall strike the dust deflector 58, which deflects the particles into the collection cavity 60. The air at the center of the tube 52 has a reduced percentage of contaminants compared to the air adjacent the interior wall of the tube 52 and may be the filtered air passed through the outlet tube 56 for the application. The vacuum source creating differential pressure for the flow in the direction indicated by arrow 62 may be positioned at the center of the spiral flow pattern.

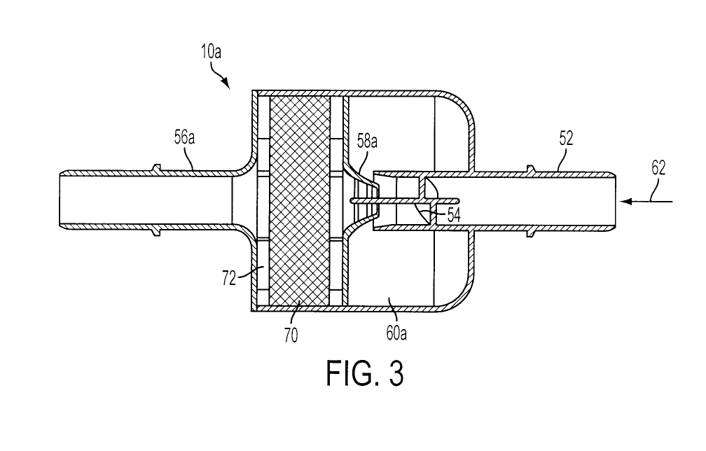

FIG. 3 illustrates another exemplary embodiment 10a of a dust separation device consistent with the present disclosure. The illustrated exemplary embodiment 10a includes an inlet tube 52 including one or more spiral fins 54 in a spiral orientation relative to the axis of the tube 52, an outlet tube 56a, a dust deflector 58a, a collection cavity 60a, and a secondary filter element 70 disposed in a chamber 72. The spiral fins 54 inside the inlet tube 52 are configured to direct incoming dust laden air in a spiral flow pattern. The spiral pattern velocity causes contaminants in the air stream to move toward the outer edge of the flow area, against the interior wall of the inlet tube 52, due to centrifugal force. As the air progresses down the inlet tube 52 past the fins 54 the contaminants near the interior wall strike the dust deflector 58a, which deflects the particles into the collection cavity 60a. The air at the center of the tube 52 has a reduced percentage of contaminants compared to the air adjacent the interior wall of the tube 52 and may be drawn through the secondary filter element 70. The secondary filter element may be a conventional filter, and may filter contaminants that are not centrifugally filtered into the collection chamber 60a. Air passing through the secondary filter element 70 may be the filtered air passed through the outlet tube 56a for the application. The vacuum source creating differential pressure for the flow in the direction indicated by arrow 62 may be positioned at the center of the spiral flow pattern.

Thus, according to one aspect of the present disclosure there is provided a dust separation device for separating contaminants from fluid. The device may include an inlet tube for receiving the fluid and the contaminants; at least one spiral fin disposed in the inlet tube for directing at least a portion of the contaminants in a spiral flow toward an interior wall of the inlet tube when the fluid is drawn through the inlet tube; and a deflector adjacent an end of the inlet tube for deflecting at least a portion of the contaminants in the spiral flow in a direction away from an axis of the inlet tube and into a collection chamber. Advantageously, a device consistent with the present disclosure may provide efficient filtration with relatively low flow resistance for a vapor management system of an internal combustion engine.

According to another aspect of the present disclosure there is provided a fuel system for an internal combustion engine. The fuel system may include: a fuel tank and a vapor management system coupled to the fuel tank. The vapor management system may include a fuel vapor storage canister for receiving fuel vapor from the fuel tank, and a dust separation device coupled the fuel vapor storage canister, the dust separation device being configured for providing filtered air to the fuel vapor storage canister for purging the fuel vapor from the fuel vapor storage canister. The dust separation device may include an inlet tube for receiving incoming air including contaminants; at least one spiral fin disposed in the inlet tube for directing at least a portion of the contaminants in a spiral flow toward an interior wall of the inlet tube when the incoming air is drawn through the inlet tube; and a deflector adjacent an end of the inlet tube for deflecting at least a portion of the contaminants in the spiral flow in a direction away from an axis of the inlet tube and into a collection chamber.

According to yet another aspect of the disclosure there is provided a method of separating contaminants from a fluid including directing the fluid and contaminants against one or more spiral fins to force at least a portion of the contaminants in a spiral flow pattern; and directing at least a portion of the contaminants in the spiral flow pattern against a deflector whereby at least a portion of the contaminants in the spiral flow are deflected in a direction away from an axis of flow and into a collection chamber.

The features and aspects described with reference to particular embodiments disclosed herein may be susceptible to combination and/or application in various other embodiments described herein. Such combinations and/or applications of such described features and aspects to such other embodiments are contemplated herein. Additionally, the embodiments disclosed herein are susceptible to numerous variations and modifications without materially departing from the spirit of the disclosed subject matter. Accordingly, the invention claimed herein should not be considered to be limited to the particular embodiments disclosed herein.

What is claimed is:

1. A dust separation device for separating contaminants from a fluid, said device comprising:
an inlet tube for receiving said fluid and said contaminants;
at least one spiral fin disposed in the inlet tube for directing at least a portion of the contaminants in a spiral flow toward an interior wall of the inlet tube when said fluid is drawn through the inlet tube; and
a deflector adjacent an end of said inlet tube for deflecting at least a portion of said contaminants in said spiral flow in a direction away from an axis of the inlet tube and into a collection chamber.

2. A device according to claim 1, wherein said deflector is provided at an end of an outlet tube, said outlet tube being configured for directing said fluid outwardly from the device.

3. A device according to claim 1, said device further comprising an outlet tube for directing said fluid outwardly from said device, and a secondary filter element disposed between said deflector and said outlet tube.

4. A fuel system for an internal combustion engine, said fuel system comprising:
a fuel tank
a vapor management system coupled to said fuel tank, said vapor management system comprising:
a fuel vapor storage canister for receiving fuel vapor from said fuel tank, and
a dust separation device coupled said fuel vapor storage canister, said dust separation device being configured for providing filtered air to said fuel vapor storage canister for purging said fuel vapor from said fuel vapor storage canister, said dust separation device comprising:
an inlet tube for receiving incoming air comprising contaminants;
at least one spiral fin disposed in the inlet tube for directing at least a portion of the contaminants in a spiral flow toward an interior wall of the inlet tube when said incoming air is drawn through the inlet tube; and
a deflector adjacent an end of said inlet tube for deflecting at least a portion of said contaminants in said spiral flow in a direction away from an axis of the inlet tube and into a collection chamber.

5. A system according to claim 4, wherein said deflector is provided at an end of an outlet tube, said outlet tube being configured for directing said filtered air to said fuel vapor storage cannister.

6. A system according to claim 4, wherein said dust separation device further comprises an outlet tube for directing said filtered outwardly from said device, and a secondary filter element disposed between said deflector and said outlet tube.

7. A method of separating contaminants from a fluid, said method comprising:
directing said fluid and contaminants against one or more spiral fins to force at least a portion of the contaminants in a spiral flow pattern; and
directing at least a portion of said contaminants in said spiral flow pattern against a deflector whereby at least a portion of said contaminants in said spiral flow are deflected in a direction away from an axis of flow and into a collection chamber.
